(19) United States
(12) Patent Application Publication
(10) Pub. No.: US 2026/0351869 A1
(43) Pub. Date: Nov. 5, 2026

(54) CLAMPING ELEMENT, CLAMPING SYSTEM, AND METHOD FOR MANUFACTURING THE CLAMPING ELEMENT

(71) Applicant: Lapp Engineering AG, Cham (CH)

(72) Inventor: Julian KLOTZ, Beuren (DE)

(73) Assignee: Lapp Engineering AG, Cham (CH)

(21) Appl. No.: 19/662,037

(22) Filed: Apr. 29, 2026

(30) Foreign Application Priority Data
May 5, 2025 (DE) 102025117148.3

(51) Int. Cl. H01R 4/50

(52) U.S. Cl. CPC H01R 4/5016

(57) ABSTRACT

A clamping element, clamping system, and method for manufacturing the clamping element. The clamping element comprising: a strand clamping portion having a clamping portion that tapers towards a free axial end of the clamping element in a direction of a longitudinal axis of the clamping element, characterized in that the clamping portion has a lateral surface with strand pockets distributed around the longitudinal axis in the lateral surface; clamping element system comprising: the clamping element and a clamping sleeve; and method for manufacturing the clamping element.

### CROSS-REFERENCES TO RELATED APPLICATIONS

This application claims the benefit of the German patent application No. 10 2025 117 148.3 filed on May 5, 2025, the entire disclosure of which is incorporated herein by way of reference.

### FIELD OF THE INVENTION

The invention relates to a clamping element, a clamping system, and a method for manufacturing the clamping element.

### BACKGROUND OF THE INVENTION

DE 10 2016 101 507 A1 discloses the prior art of the relevant technical field. Further prior art can be found in DE 201 19 531 U1.

### SUMMARY OF THE INVENTION

The objects arising from the prior art are to increase the user-friendliness of the conventional clamping element, to provide a clamping system with such a clamping element, and to provide a method that allows for the simple manufacture of such a clamping element.

These objects are solved by the teaching of the claims.

The solutions are based on the teaching of the following sections:
1. Clamping element comprising: a strand clamping portion having a clamping portion that tapers towards a free axial end of the clamping element in the direction of a longitudinal axis of the clamping element, characterized in that the clamping portion has a lateral surface with strand pockets distributed around the longitudinal axis in the lateral surface. The clamping element may be a conductor for electricity. The strand pockets may be concave recesses in the lateral surface which - in other words - create a spoon-shaped receptacle for strands. In this context, a bottom forming the strand pocket may extend from a circumferential closed edge in the lateral surface in a direction towards the longitudinal axis into the clamping portion. The bottom may be curved, for example, continuously curved. “Continuously curved” refers to a curvature that is free of steps and sharp edges. The lateral surface may correspond to that of a cone, i.e., the lateral surface may be conical and may, for example, have the form of a (straight) cone or truncated cone.
2. Clamping element according to section 1, wherein the strand pockets are distributed in the lateral surface at a predetermined interval around the longitudinal axis. Such a predetermined interval may correspond to an angle of 90°, 120°, or 180° around the longitudinal axis.
3. Clamping element according to section1 or 2, wherein there are two, three, four, or more strand pockets.
4. Clamping element according to one of sections 1 through 3, wherein the strand pockets are dimensioned and distributed such that they
   a. are spaced apart from one another, or
   b. touch one another, or
   c. intersect one another.

In this context, the strand pockets are considered as a whole. For example, if only regions of adjacent strand pockets intersect, while other regions of the same strand pockets touch one another or are spaced apart from one another, the strand pockets are to be regarded as dimensioned and distributed such that they intersect one another. “Dimensioned” refers to the shape and extent of the respective strand pocket. “Distributed” refers to the arrangement of the strand pockets around the longitudinal axis in the lateral surface.

5. Clamping element according to one of sections 1 through 4, wherein the clamping portion comprises, from the free axial end of the clamping element along the longitudinal axis, three successive axial portions:
i. a conical first portion,
ii. a conical second portion, and
iii. a conical third portion, wherein the strand pockets extend along the longitudinal axis over the entire conical second portion.

In this case, the strand pockets may extend along the longitudinal axis exclusively over the entire conical second portion, i.e., they do not protrude into the first portion or into the third portion. The conical first portion may be formed as a cone or as a truncated cone, wherein its lateral surface is uninterrupted and runs linearly. The conical second portion may constitute a truncated cone whose linearly extending lateral surface is interrupted only by the strand pockets. The conical third portion may constitute a truncated cone whose lateral surface is continuous and runs linearly. The bottom of the strand pockets may extend from the end of the second portion adjacent to the first portion to the end of the second portion adjacent to the third portion such that the bottom is closest to the longitudinal axis at the end of the second portion adjacent to the first portion.

6. Clamping element according to section 5 , wherein a bottom of the strand pockets extends along a plane, in which the longitudinal axis is arranged, from an end of the second portion adjacent to the first portion to an end of the second portion adjacent to the third portion, such that its opening angle increases from a value smaller than an opening angle of the first portion to a value greater than an opening angle of the third portion.

The length of the clamping portion may be 16.85 mm. The opening angle of the first portion and the third portion may be 60°. The half opening angle at a point on the edge located 5.62 mm from an end of the first portion facing away from the second portion on the longitudinal axis may be between 0° and 30°, for example, between 12.68° and 21.15°, for example 12.68°. The half opening angle at a point on the edge located 2 × 5.62 mm from an end of the first portion facing away from the second portion on the longitudinal axis may be between 0° and 30°, for example between 26.49° and 29.40°, for example 26.49°. The half opening angle refers to the angle between the longitudinal axis and a straight line that intersects the longitudinal axis and includes the following two points: the aforementioned point on the edge and a point on the surface of the clamping portion that lies between the first portion and the second portion.

7. Clamping element according to section 5 or 6, wherein a bottom of the strand pockets extends from the end of the second portion adjacent to the first portion to the end of the second portion adjacent to the third portion such that the bottom is closest to the longitudinal axis at the end of the second portion adjacent to the first portion.

8. Clamping element according to one of sections1 through 7, wherein the strand pockets are each produced by means of a milling cutter that is moved along a milling curve in a plane.

9. Clamping element system comprising: a clamping element according to one of sections 1 to 8 , and a clamping sleeve, wherein the clamping element and the clamping sleeve are connectable to one another via a connecting device.

The clamping element may be insertable axially along the longitudinal axis into the clamping sleeve. The connecting device may be a screw connecting device realized by means of an external thread portion of the clamping element and a corresponding internal thread portion of the clamping sleeve. Instead of such a screw connection device, an axial snap-fit connection, for example by means of snap hooks, or any other non-destructive releasable or non-destructive non-releasable connection device, for example an axial connection device, may be provided between the clamping element and the clamping sleeve.

10. Method for manufacturing a clamping element according to one of the portions1 to 8, characterized by forming one of the strand pockets by moving a milling cutter along a milling curve.

Further strand pockets may be formed by the same movement, provided that the clamping element has previously been rotated by a predetermined interval about the longitudinal axis. The milling curve may be a circular segment around a center point in the aforementioned plane. In this case, the milling curve may begin at a point closest to the longitudinal axis and move progressively further away from the longitudinal axis from there.

### BRIEF DESCRIPTION OF THE DRAWINGS

The foregoing and the following detailed description will be better understood when read in conjunction with the accompanying drawings. For illustrative purposes, preferred embodiments are shown in the drawings.

FIG. 1 shows a side view of a clamping element;

FIG. 2 shows a perspective view of the clamping element from FIG. 1;

FIG. 3 shows a front view of a clamping system, which is explained in more detail in FIG. 4, featuring the clamping element from FIG. 1 and FIG. 2;

FIG. 4 shows a perspective view of the clamping system from FIG. 3 with the clamping element from FIG. 1 and FIG. 2;

FIG. 5 shows a side view of the clamping system from FIG. 4;

FIG. 6 shows an exploded view of the side view of the clamping system from FIG. 5;

FIG. 7 shows a side view (left) and a front view (right) of a variant of the clamping element with two strand pockets;

FIG. 8 shows a side view (left) and a front view (right) of a variant of the clamping element with three strand pockets;

FIG. 9 shows a side view (left) and a front view (right) of a variant of the clamping element with four strand pockets;

FIG. 10 shows two additional variants of the clamping element with three strand pockets;

FIG. 11 shows three variants of a milling curve for producing a strand pocket; and

FIG. 12 shows a milling cutter for and during the production of a strand pocket.

### DETAILLED DESCRIPTION OF PREFERRED EMBODIMENTS

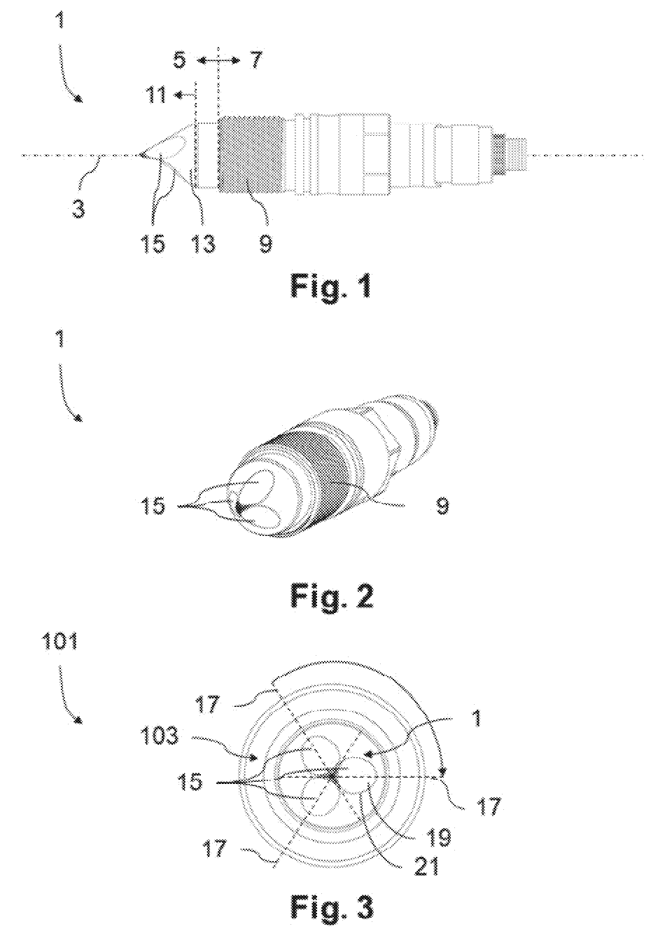

FIG. 1 shows a side view of a clamping element 1.

The clamping element 1 extends along a longitudinal axis 3. It comprises a strand clamping portion 5 and a connection portion 7 adjoining it. Both portions 5 and 7 are separated from one another in FIG. 1 by a vertical dashed line running perpendicular to the longitudinal axis 3.

The connection portion 7 comprises an external thread portion 9, the function of which is explained below.

The strand clamping portion 5 has a clamping portion 11 that tapers towards a free axial end of the clamping element 1 in the direction of the longitudinal axis 3. The clamping portion 11 has a lateral surface 13 with strand pockets 15 distributed around the longitudinal axis 3 in the lateral surface 13. Of the three strand pockets 15 present in this variant of the clamping element 1, only two are visible here due to the perspective of the view.

FIG. 2 shows a perspective view of the clamping element 1 from FIG. 1.

In this view of the clamping element 1, all three strand pockets 15 are visible. The latter are distributed around the longitudinal axis 3 at a predetermined interval in the lateral surface 13. Here, the predetermined interval around the longitudinal axis 3 corresponds to an angle of 120°. The extent of the strand pockets 15 in the circumferential direction - i.e., along the lateral surface 13 and transverse to the longitudinal axis 3 - is selected such that the strand pockets 15 are spaced apart from one another in the circumferential direction. Alternatively, the strand pockets 15 may touch one another or intersect one another.

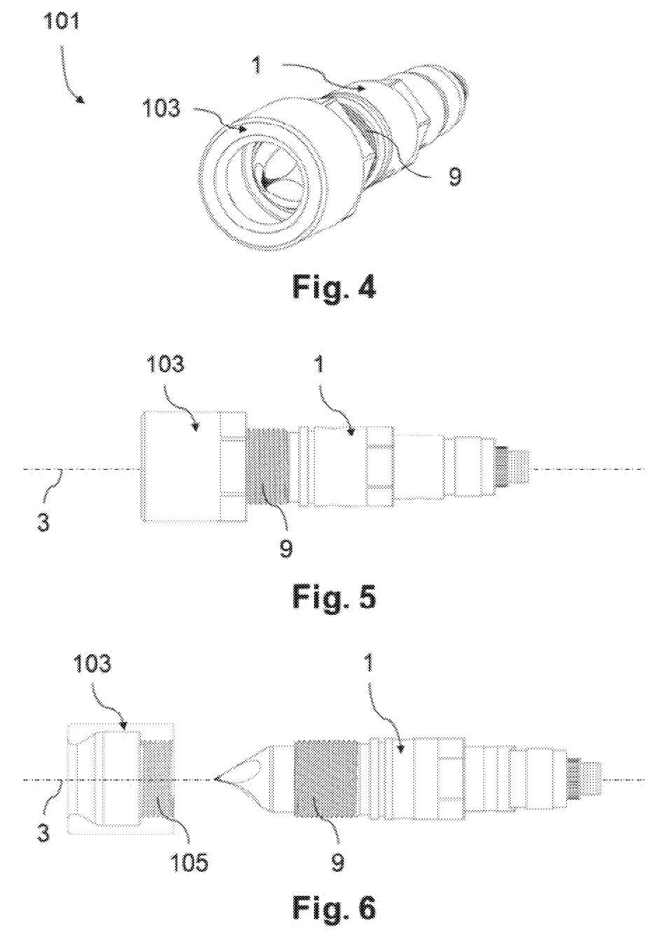

FIG. 3 shows a front view of a clamping system 101, which is explained in more detail in FIG. 4, featuring the clamping element 1 from FIG. 1 and FIG. 2.

This view corresponds to a view of the clamping element 1 from the left towards the longitudinal axis 3. The strand pockets 15 and their distribution at the aforementioned interval can be seen here. The interval, which corresponds here to an angle of 120°, is illustrated by way of example by the circumferential arrow, which denotes the angle between two planes 17. Each of these planes 17 is a plane of symmetry in which the longitudinal axis 3 lies and which divides at least the strand clamping portion 5 along the longitudinal axis 3 into two symmetrical halves. It should also be noted that at least one, in this case each, strand pocket 15 is symmetrical with respect to a plane 17 passing through the respective strand pocket. Here, too, it can be seen that the strand pockets 15 are spaced apart from one another in the circumferential direction.

FIG. 1 through FIG. 3 show that here each strand pocket 15 constitutes a concave recess in the lateral surface 13, which - in other words - creates a spoon-shaped receptacle for strands. In this configuration, a bottom 19 forming the strand pocket 15 extends from a circumferential, closed edge 21 in the lateral surface 13 in a direction towards the longitudinal axis 3 into the clamping portion 11. The bottom 19 may be curved, for example, continuously curved.

FIG. 4 shows a perspective view of the clamping system 101 from FIG. 3 with the clamping element 1 from FIG. 1 and FIG. 2.

Here, the clamping system 101 is shown such that it comprises the clamping element 1 depicted in FIG. 2 and, additionally, a clamping sleeve 103 into which the clamping element 1 is inserted axially along the longitudinal axis and to which the clamping element 1 is connected. In this case, a screw connection device described later is used as an example for the connection. Of course, instead of such a screw connection device, for example, an axial snap-fit connection, such as by means of snap hooks, or any other non-destructive releasable or non-destructive non-releasable connection device, such as an axial connection device, may be provided between the clamping element 1 and the clamping sleeve 103. As can already be seen in FIG. 3, the strand pockets 15 extend within a radius around the longitudinal axis that is smaller than the smallest inner radius of the clamping sleeve 103, so that the strand pockets 15 are fully visible in the front view shown in FIG. 3 when the clamping element 1 is inserted axially into the clamping sleeve 103 along the longitudinal axis and is connected to the clamping sleeve 103.

FIG. 5 shows a side view of the clamping system 101 from FIG. 4.

It can be seen that the clamping element 1 and the clamping sleeve 103 are arranged in a fixed position relative to one another along the longitudinal axis 3 by means of the screw connection device, to which the shown external thread portion 9 belongs. This position can only be changed here by rotating the clamping element 1 and the clamping sleeve 103 relative to one another about the longitudinal axis 3.

FIG. 6 shows an exploded view of the side view of the clamping system 101 from FIG. 5.

Here, the clamping sleeve 103 is shown in a longitudinal cross-section to illustrate its internal threaded section 105. The external thread portion 9 of the clamping element 1 engages with this internal threaded section 105.

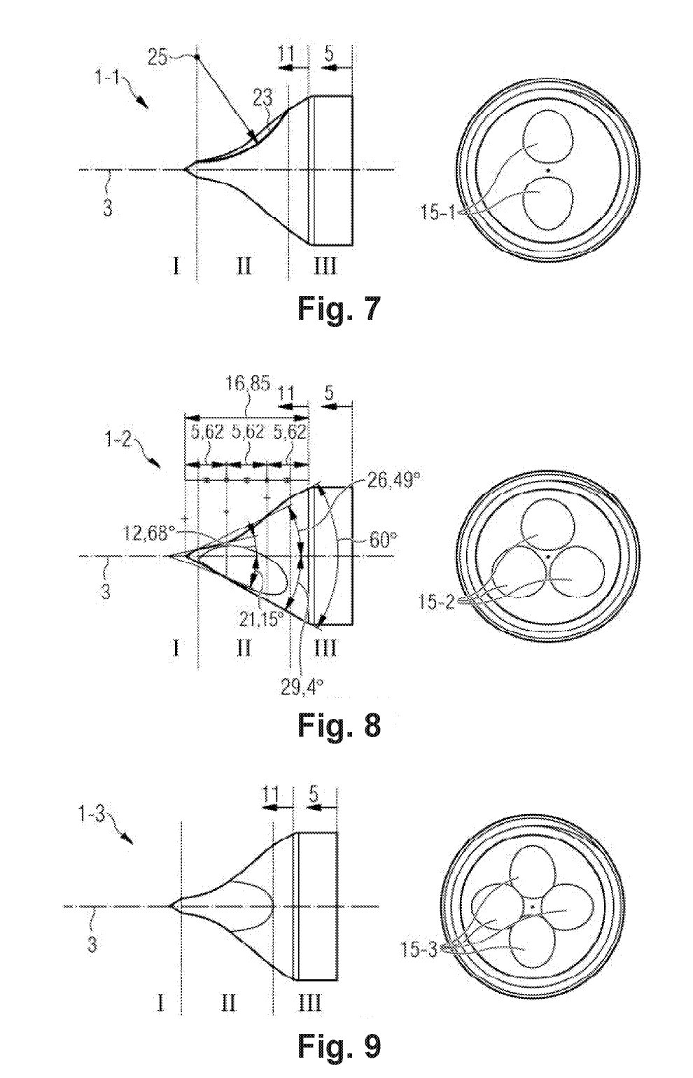

FIG. 7 shows a side view (left) and a front view (right) of a variant of the clamping element 1-1 with two strand pockets 15-1. For this purpose, only a portion corresponding to the strand clamping portion 5 is shown here. The specified interval around the longitudinal axis 3 corresponds here to an angle of 180°. The strand pockets 15-1 are distributed such that they are spaced apart from one another. Alternatively, they could be dimensioned and distributed here such that they touch one another or intersect one another.

The strand pockets 15-1 are produced - as in all variants described here - for example, using a milling cutter that is moved along a milling curve 23 in a plane in which the longitudinal axis 3 lies. The milling curve 23 shown here lies in a plane 17 passing centrally through the respective strand pocket 15-1. The milling curve 23 corresponds here to a circular segment around a center point 25 lying in the aforementioned plane 17.

As can be seen in particular in FIGS. 1 and 6 due to the similar side view, the clamping portion 11 comprises, from the free axial end of the clamping element 1-1 along the longitudinal axis 3, the following three successive axial portions:
a conical first portion I,
ii. a conical second portion II, and
iii. a conical third portion III.

The strand pockets 15-1 extend along the longitudinal axis 3 over the entire conical second portion II. As shown here, the strand pockets 15-1 may extend along the longitudinal axis 3 exclusively over the entire conical second portion II, i.e., they do not protrude into the first portion I and also not into the third portion III.

The conical first portion I may be formed as a cone or as a truncated cone, wherein its lateral surface is uninterrupted and runs linearly. The conical second portion II is a truncated cone whose linearly extending lateral surface is interrupted only by the strand pockets 15-1. The conical third portion III is a truncated cone whose lateral surface is continuous and runs linearly.

The bottom 19 of the strand pockets 15-1 extends here and in all other shown variants from the end of the second portion II adjacent to the first portion I to the end of the second portion II adjacent to the third portion III in such a way that the bottom 19 is closest to the longitudinal axis 3 at the end of the second portion II adjacent to the first portion I.

At the same time, it can be seen that the center point 25 lies transverse to the longitudinal axis 3 and above the boundary between the first portion I and the second portion II.

FIG. 8 shows a side view (left) and a front view (right) of a variant of the clamping element 1-2 with three strand pockets 15-2. For this purpose, only one portion corresponding to the strand clamping portion 5 is shown here. The specified interval around the longitudinal axis 3 corresponds here to an angle of 120°. The strand pockets 15-2 are distributed such that they are spaced apart from one another. Alternatively, they could be dimensioned and distributed here such that they touch one another or intersect one another.

Here and in each other variant, each strand pocket 15-2 has a bottom 19 that extends along a plane 17, in which the longitudinal axis 3 lies, from the end of the second portion II adjacent to the first portion I to the end of the second portion II adjacent to the third portion III, such that its opening angle increases from a value smaller than an opening angle of the first portion I to a value greater than an opening angle of the third portion III.

According to a specific variant shown here, the following dimensions shall apply: The length of the clamping portion 11 shall be 16.85 mm. The opening angle of the first portion I and the third portion III shall be 60°. The half opening angle at a point on the edge 21 located 5.62 mm from an end of the first portion I facing away from the second portion II on the longitudinal axis 3 shall be between 0° and 30°, for example between 12.68° and 21.15°, for example 12.68°. The half opening angle at a point on the edge 21 located 2 × 5.62 mm from an end of the first portion I facing away from the second portion II on the longitudinal axis 3 shall be between 0° and 30°, for example between 26.49° and 29.40°, for example 26.49°. The half opening angle refers to the angle between the longitudinal axis 3 and a straight line that intersects the longitudinal axis 3 and passes through the following two points: the aforementioned point on the edge 21 and a point on the surface of the clamping portion 11 that lies between the first portion I and the second portion II.

FIG. 9 shows a side view (left) and a front view (right) of a variant of the clamping element 1-3 with four strand pockets 15-3. For this purpose, only a portion corresponding to the strand clamping portion 5 is shown here. The specified interval around the longitudinal axis 3 corresponds here to an angle of 90°. In this variant, the strand pockets 15-3 are distributed such that they intersect one another. Alternatively, they could be dimensioned and distributed such that they are spaced apart from one another or touch one another.

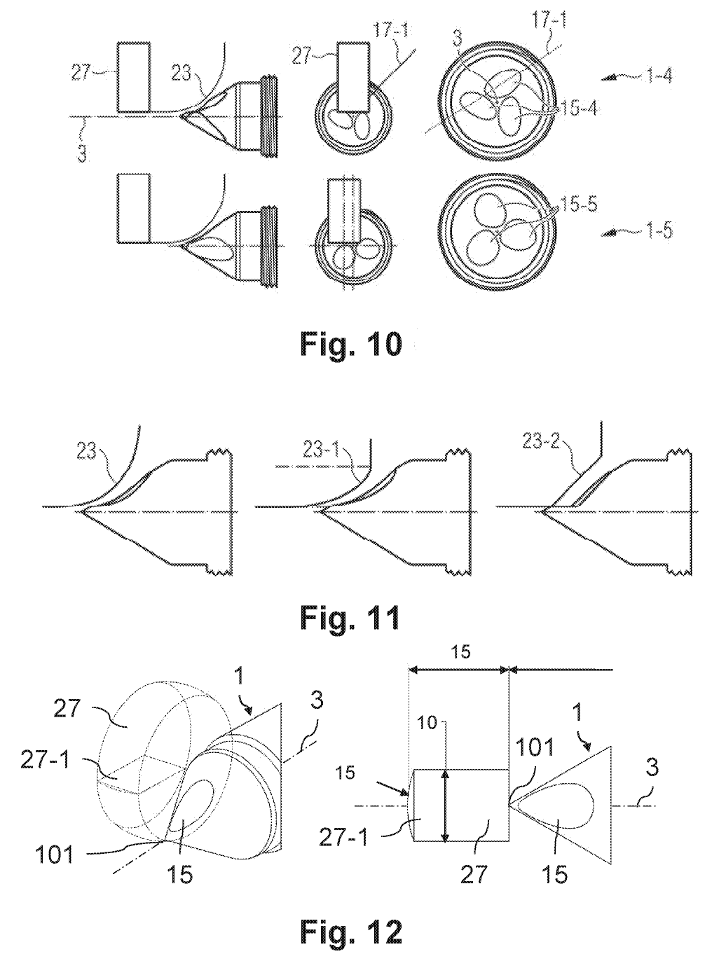

FIG. 10 shows two further variants of the clamping element 1-4, 1-5 with three strand pockets 15-4, 15-5.

In the upper half of FIG. 10, the strand pockets 15-4 are each formed along a plane 17-1 that is parallel to the longitudinal axis 3 and spaced apart from the longitudinal axis 3. Here, only plane 17-1 for the upper of the three strand pockets 15-4 is shown as an example. The other two strand pockets 15-4 have corresponding planes. A milling cutter 27 is shown here moving along the milling curve 23 in plane 17-1 (left) and along plane 17-1 (center).

In the lower half of FIG. 10, the strand pockets 15-5 are produced by moving the milling cutter 27 along the milling curve 23 while the plane of the milling curve 23 is shifted from an initial plane in a direction orthogonal to the initial plane and/or rotated about the longitudinal axis 3, wherein the center of this rotation may lie on the longitudinal axis 3. This results in a plane path. In this process, while the milling cutter 27 is moved along the milling curve 23, the center point may be a fixed or a moving point. Thus, this point may lie on the longitudinal axis 3 or move along the longitudinal axis 3. Naturally, the initial plane may correspond to one of the previously mentioned planes 17, 17-1.

The strand pockets 15-4, 15-5 are thus asymmetrical, in contrast to the strand pockets 15-1, 15-2, 15-3, which are all symmetrical. The same applies to the strand clamping portion, the clamping portion, and/or the clamping element. Thus, there is no plane of symmetry here in which the longitudinal axis 3 lies.

FIG. 11 shows three variants of a milling curve 23, 23-1, 23-2 for producing a strand pocket 15.

The milling curves 23, 23-1 shown here 23-2 correspond to a circular segment (milling curve 23), a parabolic portion or an elliptical portion (milling curve 23-1), and a linear portion (milling curve 23-2) in a plane, for example in the previously mentioned plane 17 or 17-1. When the term “correspond to” is used, it should be understood to mean “comprise” or “consist of.” Thus, a circular segment may form a part of the milling curve 23 (“comprise”) or define the entire milling curve (“consist of”). The first and last contact of a milling cutter with the clamping element can be understood as the start and the end of the milling curve.

Planes 17, 17-1, plane profiles, and milling curves 23, 23-1, 23-2 can be combined from the aforementioned variants to produce strand pockets 15, 15-1, 15-2, 15-3, 15-4, 15-5.

In a method for manufacturing a clamping element 1 described herein, one of the strand pockets 15, 15-1, 15-2, 15-3, 15-4, 15-5 may be formed by moving the milling cutter 27 along the milling curve 23, 23-1, 23-2.

FIG. 12 shows a form milling cutter used for and during the production of a strand pocket 15.

The strand pocket 15 shown here is created using a milling cutter 27 known as a form milling cutter. This may apply to all strand pockets 15. In machining manufacturing, the available production machines typically define the possibilities of the manufacturing method. Depending on the machine type or machine characteristics, it may be advantageous to create a geometric element, such as the strand pocket 15 shown here, using a form milling cutter rather than by following a defined curve with a standard end shaft miling cutter - as shown in FIG. 10 and FIG. 11 and described above. The form milling cutter itself is designed such that the geometry of its cutting edge exactly matches the negative profile of the desired workpiece shape, in this case the strand pocket 15. In other words, the cutting geometry of the milling cutter 27 corresponds to the negative profile of wire pocket 15. This allows production to be accelerated and simplified.

In the left half of FIG. 12, the milling cutter 27 is depicted using dashed lines as a cylindrical body with two circular, parallel, and coaxial surfaces connected by a convex, circumferential edge. The cross-sectional area 27-1 in a plane intersecting the central axis of the milling cutter 27 which is shown in the left half of FIG. 12 is shown in a top view in the right half of FIG. 12. Dimensions are included therein. Thus, the convex edge has a radius of 15 mm. The thickness of the milling cutter 27, i.e., the distance between the two parallel surfaces, is 10 mm. The radius of the milling cutter 27, measured perpendicular to and from the axis of the milling cutter 27 to the outermost point of the convex edge, is also 15 mm. Thus, it may be the case that both of the aforementioned radii should be equal, wherein these do not necessarily have to be 15 mm. Furthermore, the thickness of the milling cutter 27 may be two-thirds of the radius of the milling cutter 27. During manufacturing, the clamping element 1, for producing its strand pockets 15 using such a milling cutter 27, may be rotated about its longitudinal axis 3 to the extent necessary to produce the strand pockets 15 one after another. Alternatively, all strand pockets may be produced simultaneously using several such milling cutters 27. Furthermore, the axis of the milling cutter 27 may lie in a plane that is perpendicular to the longitudinal axis 3 of the clamping element 1 and above a tip 101 of the clamping element 1 located on this longitudinal axis 3.

The clamping element described here, along with its variants, facilitates the spreading of stranded bundles at the start of a cable installation. This is particularly noticeable with larger cable cross-sections, as these become more difficult to install by hand as the cross-section increases. Furthermore, the risk of bending or crushing the stripped section of the cable is reduced, which is particularly high at the start of cable insertion. This makes it possible to provide an axial connection that covers a wide range of cable cross-sections. Such a cable cross-sectional area range comprises cable cross-sections from 35 mm² (or less) to 240 mm² (or more). The partial tapering achieved by the strand pockets 15 also preserves the basic shape of the standard tip and ensures a uniformly round contact surface in the rear area.

Twisted strand pockets 15 or strand pockets 15 created with the milling cutter 27 (a form milling cutter) could be used if, for example, a spindle is missing on a lathe.

What is claimed is:

1. Clamping element comprising:
a strand clamping portion having a clamping portion that tapers towards a free axial end of the clamping element in a direction of a longitudinal axis of the clamping element;
characterized in that the clamping portion has a lateral surface with strand pockets distributed around the longitudinal axis in the lateral surface.

2. Clamping element according to claim 1, wherein the strand pockets are distributed in the lateral surface at a predetermined interval around the longitudinal axis.

3. Clamping element according to claim 1, wherein there are two, three, four, or more strand pockets.

4. Clamping element according to claim 1, wherein the strand pockets are dimensioned and distributed such that they:
a) are spaced apart from one another; or
b) touch one another; or
c) intersect one another.

5. Clamping element according to claim 1, wherein the clamping portion of the clamping element comprises, from the free axial end of the clamping element along the longitudinal axis, three successive axial portions:
i) a conical first portion;
ii) a conical second portion; and
iii) a conical third portion;
wherein the strand pockets extend along the longitudinal axis across the entire conical second portion.

6. Clamping element according to claim 5, wherein a bottom of the strand pockets extends along a plane, in which the longitudinal axis is arranged, from an end of the second portion adjacent to the first portion to an end of the second portion adjacent to the third portion in such a way that its opening angle increases from a value smaller than an opening angle of the first portion to a value greater than an opening angle of the third portion.

7. Clamping element according to claim 5, wherein a bottom of the strand pockets extends from the end of the second portion adjacent to the first portion to the end of the second portion adjacent to the third portion such that the bottom is closest the longitudinal axis at the end of the second portion adjacent to the first portion.

8. Clamping element according to claim 1, wherein the strand pockets are each produced by means of a milling cutter.

9. Clamping element system comprising:
a clamping element according to claim 1; and
a clamping sleeve;
wherein the clamping element and the clamping sleeve are connectable to one another via a connecting device.

10. Method for manufacturing a clamping element according to claim 1,
characterized by forming one of the strand pockets by moving a milling cutter.
